(19) United States
(12) Patent Application Publication
(10) Pub. No.: US 2024/0391275 A1
(43) Pub. Date: Nov. 28, 2024

(54) Means for fixing swivel wheels of non-motorized vehicle in parallel to one direction Description

(71) Applicant: Mogogo Ltd., Tel Aviv (IL)

(72) Inventors: Yariv Kadosh, Tel Aviv (IL); Mordehay Ben Aharon, Tel Aviv (IL)

(73) Assignee: Mogogo Ltd, Tel Aviv (IL)

(21) Appl. No.: 18/202,925

(22) Filed: May 28, 2023

(51) Int. Cl. B60B 33/00

(52) U.S. Cl. CPC B60B 33/0073

(57) ABSTRACT

A parallel fixation means for fixing two swivel wheels of a non-motorized vehicle in parallel to one direction that includes a rigid strip with connecting means for connecting the parallel fixation means to a body of the non-motorized vehicle and two locking means to be mounted on the two swivel wheels and to fix them in parallel to the one direction for preventing a rotation of the swivel wheels. The two locking means are connected to the rigid strip by means of pivot connections to be in a fixed direction or in a loose and free to rotate position. When the pivot connections are in the fixed direction the two swivel wheels are fixed in the one direction, and when the pivot connections are in the loose and free to rotate position the two swivel wheels are free to function as swivel wheels.

### TECHNICAL FIELD

The present invention refers to a parallel fixation means for fixing swivel wheels of a non-motorized vehicle in parallel to one direction relative to the non-motorized vehicle.

### BACKGROUND ART

A caster is a wheel that is designed to be attached to the bottom of an object to enable that object to be moved, such as shopping charts, food serving charts, hospital beds and the like (Hereinafter and in the claims the “a non-motorized vehicle”). Rigid casters are fixed to the vehicle to be rolled along a straight line path and swivel casters are mounted on a pivot such that the wheel is automatically align itself to the direction of travel of the vehicle.

When it comes to choosing casters, one of the first decisions the buyer should make is rigid or swivel. Here's what the buyer needs to know. Rigid Casters: One Direction Rigid or “fixed” casters allow moving the vehicle back and forth in a straight line. They can't turn corners, but they're stronger than swivel casters and can support heavier loads. When using rigid casters, there is a need to make sure they all line up in the same direction. Swivel Casters: Any Direction the user needs maneuverability, swivel casters are best choice. Swivel casters rotate 360 degrees; so that the user can turn corners, move the cargo sideways, and so on. They're also harder to move in a straight line and change direction. That's why shopping charts, for example, have fixed casters in back and swivel casters in front. The fixed casters at the back act as a fulcrum, making it easier to turn corners and also to move the chart in a straight line.

Today there is either a Swivel or Rigid wheel, but not integrated. A Rigid wheel requires a square plate to determine its position and parallelism. This reduces the variety of rigid wheels in the market. The solution of the present invention makes it possible with the help of a simple device and a dedicated wheel to convert a Swivel wheel into a Rigid wheel with a definite direction of movement. This is done without intervention in the wheel itself or its surrounding.

Also, fixed rigid wheels include an upper plate that is attached, usually with four screws, to the bottom of the vehicle, and usually to the lower end of a leg of the vehicle, which limits its use. On the other hand, connecting a swivel wheel to the bottom of the leg of the vehicle is done by threading of a screw, as usual. Therefore, in cases where there is not enough place to attach a plate and yet a rigid wheel is desired, then it is possible to use a swivel wheel and fix it using the application of the present invention.

### LIST OF DRAWINGS

The intention of the drawings attached to the application is not to limit the scope of the invention and its application. The drawings are intended only to illustrate the invention and they constitute only one of its many possible implementations.

FIG. 1 depicts the non-motorized vehicle (10).

FIG. 2 depicts a swivel wheel (30) and a parallel fixation means (40).

FIGS. 3 and 4 depict two swivel wheels (30) and the parallel fixation means (40) in process of contention to the body (not shown).

FIG. 5 depicts the parallel fixation means (40).

FIG. 6 depicts schematically a front view of one swivel wheel and the parallel fixation means.

FIG. 7 depicts schematically a side view of one swivel wheel and the parallel fixation means.

FIG. 8 depicts the parallel fixation means with a telescoping rigid strip.

### THE INVENTION

The main objective of the present invention is to provide a non-motorized vehicle (10) that comprises a body (20), at least two swivel wheels (30) that are connected by screws (31) to a bottom (11) of the non-motorized vehicle, and a parallel fixation means (40) that fix the at least two swivel wheels in parallel to one direction (50); wherein said parallel fixation means (40) comprises a rigid strip (41) which includes connecting means (42) for connecting the parallel fixation means to the body of the vehicle and two locking means (43) that are designed to mount on a certain part (32) of the swivel wheels and fix them in parallel to the one direction and prevent them from rotating. Another object of the present invention is to provide the parallel fixation means (40) itself.

The rigid strip (41) of the parallel fixation means (40) can be a flat metal strip that includes two holes that serves as the connecting means (42) of the parallel fixation means to the body, by screws and possible by the screws (31) of the swivel wheels that are designed to be screwed into the body.

The locking means (43) that are designed to mount on the certain part (32) of the swivel wheels and to fix them in parallel to one direction and prevent them from rotating can be, for example, a type of pin (which is designed to penetrate designated holes in the swivel wheels that serve as the certain part), a type of tab or a piece (which is designed to penetrate a space or gap in the swivel wheels that serve as the certain part), a type of grasper (which is designed to tightly hold some part of the wheels that serve as the certain part in a way that prevents them from rotating).

The orientation of the locking means is parallel due to the fact that they are connected in parallel to the rigid strip, such that they are oriented in the same direction. When the parallel fixation means is assembled on the swivel wheels when they are connected to the body they are fixed in the same direction (the direction of travel of the vehicle).

In addition to this, since it is possible to connect the parallel fixation means to the body of the vehicle using the screws of the swivel wheels that are screwed into designated holes in the vehicle, this creates a precise adjustment of the locking means in the same direction, so that the swivel wheels are locked and fixed in the same direction, a connection that is very important to enable efficient and smooth driving of the vehicle. Also, it is possible for the rigid strip to be telescopic, as depicted for example in FIG. 8, to allow it to be used for a variety of vehicles, and when assembling the swivel wheels, the rigid strip is opened to the appropriate size.

The two locking means (43) of the parallel fixation means (40) may be connected to the rigid strip (41) by means of pivot connections (44) that are designed to enable the two locking means to fix the two swivel wheels (30) in the one direction and to release the two swivel wheels (30) from the fixation and to enable the two swivel wheels (30) to function as swivel wheels. In other words, the two locking means can be connected to the rigid strip by the means of pivot connections that are designed to be in a fixed direction or in a loose and free to rotate position. When the pivot connections are in the fixed direction the two swivel wheels are fixed in the one direction, and when the pivot connections are in the loose and free to rotate position the two swivel wheels are free to function as swivel wheels.

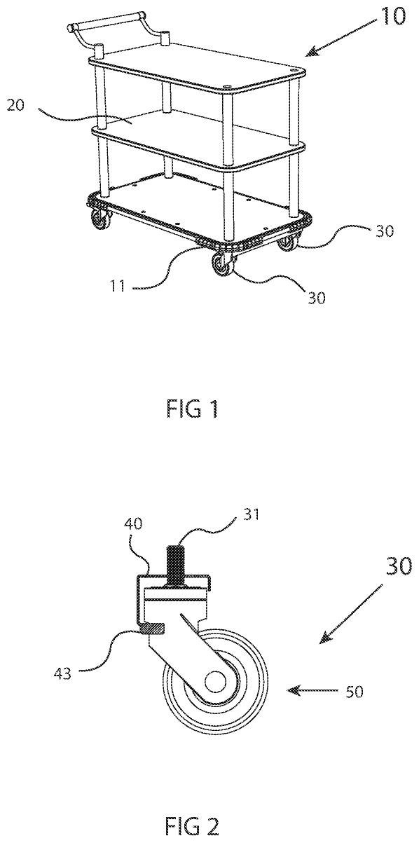

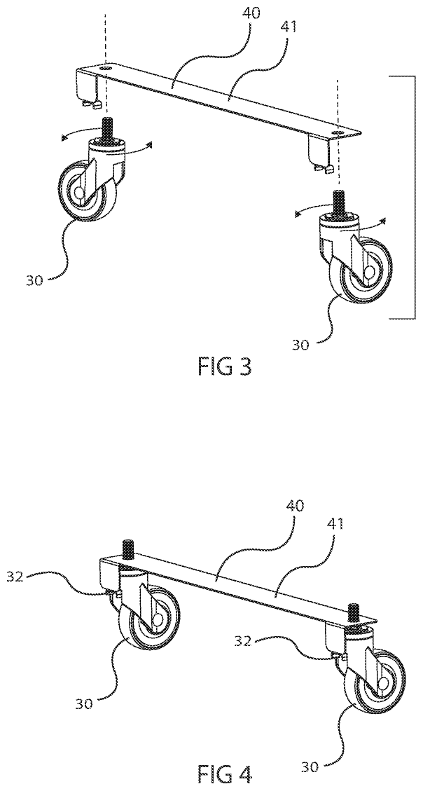

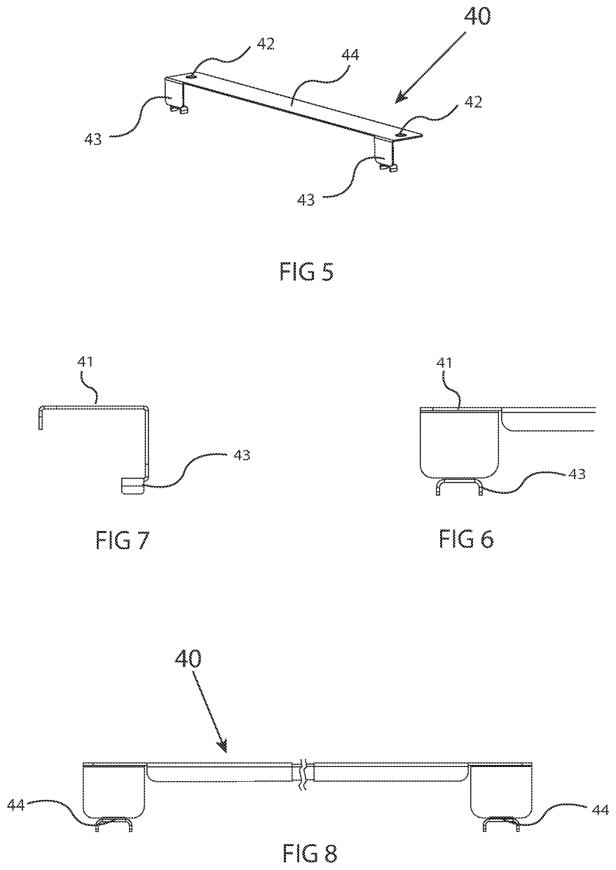

FIG. 1 depicts the non-motorized vehicle (10), FIG. 2 depicts the swivel wheel (30) on which assembled the parallel fixation means (40), FIGS. 3 and 4 depict two swivel wheels (30) and the parallel fixation means (40) in process of contention to the body (not shown), FIG. 5 depicts the parallel fixation means (40), FIG. 6 depicts schematically a front view of one swivel wheel and the parallel fixation means, FIG. 7 depicts schematically a side view of one swivel wheel and the parallel fixation means, and FIG. 8 depicts the parallel fixation means with a telescoping rigid strip.

What is claimed is:

1. A parallel fixation means for fixing two swivel wheels of a non-motorized vehicle in parallel to one direction; wherein the parallel fixation means comprises a rigid strip that includes connecting means for connecting the parallel fixation means to a body of the non-motorized vehicle and two locking means that are designed to be mounted on the two swivel wheels and fix them in parallel to the one direction for preventing a rotation of said two swivel wheels.

2. The parallel fixation means of claim 1 wherein said two locking means are connected to said rigid strip by means of pivot connections that are designed to be in a fixed direction or in a loose and free to rotate position; wherein when the pivot connections are in the fixed direction said two swivel wheels are fixed in said one direction; and wherein when the pivot connections are in the loose and free to rotate position the two swivel wheels are free to function as swivel wheels.

3. A non-motorized vehicle that comprises a body, at least two swivel wheels that are connected by screws to a bottom of the non-motorized vehicle, and a parallel fixation means that fix the at least two swivel wheels in parallel to one direction; wherein said parallel fixation means comprises a rigid strip which includes connecting means for connecting the parallel fixation means to the body of the vehicle and two locking means that are designed to be mounted on the swivel wheels and fix them in parallel to the one direction for preventing a rotation of said two swivel wheels.

4. The non-motorized vehicle of claim 3 wherein said two locking means are connected to said rigid strip by means of pivot connections that are designed to be in a fixed direction or in a loose and free to rotate position; wherein when the pivot connections are in the fixed direction said two swivel wheels are fixed in said one direction; and wherein when the pivot connections are in the loose and free to rotate position the two swivel wheels are free to function as swivel wheels.
